(19) United States
(12) Patent Application Publication
(10) Pub. No.: US 2004/0009457 A1
(43) Pub. Date: Jan. 15, 2004

(54) Process for assessing and developing emotional intelligence in early childhood

(76) Inventors: Andrea Goodman Weiner, New Hope, PA (US); Judith L. Jacobson, Gwynedd Valley, PA (US); Donna Evans Strauss, Doylestown, PA (US); Lisa Pretecrum, Doylestown, PA (US); Tammy Russeck, Doylestown, PA (US)

Correspondence Address: Wendy W. Koba, PO Box 556, Springtown, PA, 18081, US

(21) Appl. No.: 10/621,156

(22) Filed: Jul. 14, 2003

Related U.S. Application Data
(60) Provisional application No. 60/395,259, filed on Jul. 12, 2002.

(51) Int. Cl. G09B 19/00

(52) U.S. Cl. 434/236

(57) ABSTRACT

A process for assessing and developing an individual's emotional intelligence is preferably utilized with young children who are still in the process of developing their various emotional states (i.e., happy, sad, angry, scared, jealous, surprised, worried, embarrassed, shy, proud). A hierarchical definition of emotional building blocks ((1) awareness of self and others; (2) emotional management; (3) empathy and compassion; (4) self-motivation and optimistic thinking; and (5) management of peer relationships) is used to provide an orderly progression through various learning activities. A set of age-appropriate learning objects (e.g., toys and games) are developed and associated with each one of the building blocks. A parent/caretaker/teacher then uses the learning object with the individual/child to assist him/her in developing the associated set of emotional states.

### CROSS-REFERENCE TO RELATED APPLICATION

This application claims the benefit of U.S. Provisional Application No. 60/395,259, filed Jul. 12, 2002.

### TECHNICAL FIELD

The present invention relates to a process for assessing and developing emotional intelligence and, more particularly to the utilization of an intentional process of using games and interactive learning objects to aid individuals (for example, young children) in recognizing and developing various emotional states.

### BACKGROUND OF THE INVENTION

The term “emotional intelligence” was first used in 1990 by Peter Salovey and John Mayer, two psychologists interested in understanding people beyond the well-known metric of one's IQ, or “intelligence quotient”. Five years later, this concept was popularized in the book Emotional Intelligence, by Daniel Goleman. Goleman defined emotional intelligence as “abilities such as being able to motivate oneself and persist in the face of frustrations; to control impulse and delay gratification, to regulate one's moods, and keep distress from swamping the ability to think, to empathize, and to hope”. Simply put, emotion intelligence is the collection of emotional qualities that guide us in how we feel, think and take action in our lives. Emotional intelligence determines how we interact with people and our own self-awareness.

As IQ is to intelligence, so is “EQ” synonymous with emotional intelligence. The most important difference between IQ and EQ is that EQ is less genetically determined. For children, this means that their EQ can be influenced to a greater extent (and therefore, increased) by their parents or other caregivers, particularly since a child's brain continues to grow, especially between the ages of three and eight. Research in brain physiology has shown that all individuals have components in the brain that comprise the “emotional brain” and the “thinking brain”. Children can learn approaches that trigger the circuits between the emotional and thinking brains to work more effectively. The goal of emotional intelligence is to have both brains partner together and interact well.

A national study of children compared their emotional well-being in the mid-1970s and at the end of the 1980s. The study found that at the end of the 1980s, children had more worries and were more unhappy, anxious, depressed and ill-tempered than their counterparts in the mid-1970s. This rise in the number of children with emotional problems, accompanied by a breakdown of children's emotional skills, has been attributed to family instability and violence in both society and the media.

There are at least five well-known building blocks, hierarchical in form, that are associated with the processing of learning and knowing one's emotions: (1) Awareness of self and others—understanding and identifying feelings; understanding the difference between thinking, feeling, and acting; understanding that one's actions have consequences in terms of others' feelings; (2) Emotional management—handling and managing difficult feelings; controlling impulses; handling anger constructively; (3) Empathy and compassion—being able to take someone else's perspective; the ability to put yourself in “someone else's shoes”; having the ability to show that you care; (4) Self-motivation and optimistic thinking—being able to set goals and use perseverance and optimistic thinking to reach them, even in the face of setbacks; and (5) Management of peer relationships—having the ability to make friends and understand and handle relationships; resolving conflicts that arise; learning cooperative, collaborative social skills.

Developing emotional intelligence involves an awareness of what is underneath the actual feelings, as well as awareness of any secondary emotions that may be present. For example, although a child may be expressing anger, they may also be feeling fear, worry or inadequacy. By understanding the triggers, the underlying emotions may also be understood. If a child is upset, the parent, teacher, or caretaker questions the child to help learn what is underneath the projected emotional state. Underneath this secondary feeling is a thought or belief. As a result of this underlying belief, the intensity of the projected emotion is not always in concert with the present situation. For example, the present situation may have triggered a past phenomenon and underlying issues, thereby creating an inappropriate over-reaction to the circumstance.

Managing emotions is important, since powerful emotions can overwhelm thoughts and abilities that may stop an individual from being able to take the appropriate coping action. Thus, a need remains for developing a set of tools to assist parents, caretakers and teachers to assist a child in developing a healthy “emotional intelligence”. Moreover, such a set of tools would be useful with people of any age to evaluate (and perhaps improve) their emotional intelligence level.

### SUMMARY OF THE INVENTION

The need remaining in the prior art is addressed by the present invention, which relates to a process for assessing and developing emotion intelligence and, more particularly, to the utilization of an intentional process of using games and interactive learning objects to aid individuals (for example, young children) in recognizing various emotional states. A first set of “primary” emotional states, for the purposes of the present invention is defined as follows: happy, sad, angry, scared, and proud. A second set of “secondary” emotional states is defined as including the following: jealous, embarrassed, worried, surprised and shy.

In accordance with the methodology of the present invention, a process has been developed for engaging an individual (for example, a child) in “play” that sequentially utilizes a set of teaching aids to address the five different hierarchical building blocks of: (1) awareness of self and others; (2) emotional management; (3) empathy and compassion; (4) self-motivation and optimistic thinking; and (5) management of peer relationships as associated with the various primary and secondary emotional states.

The process of the present invention itself is directed to, in one, embodiment, three different (yet overlapping) age ranges; infant to 3 years old, 3-5 years old, and 5-7 years old. It is to be understood that these age ranges are exemplary only, and various children may fall in different categories as a result of various other emotional, intelligence or environmental issues. Indeed, the methodology of the present invention is equally applicable in addressing higher-level emotional intelligence skills (perhaps associated with the secondary emotional states) as are developed by teenagers and/or adults. In each age grouping, only the manipulatives or learning objects need be modified to reflect age-appropriate situations.

### BRIEF DESCRIPTION OF THE DRAWINGS

Referring now to the drawings,

FIG. 1 includes a flowchart illustrating the overall methodology of the present invention as used to assess and develop a child's emotional skills;

FIG. 2 contains a table of an exemplary “emotional state” mastery scale that may be used during the inventive process to assess an individual's success with the particular aspect of emotional growth associated with a selected learning object; and

FIG. 3 illustrates one exemplary learning object, in the form of a “toy”, that may be used with the process of FIG. 1 to work on the initial building block awareness of basic “emotional expressions” in self and others.

### DETAILED DESCRIPTION

It has been found that children who can control their emotions and appropriately express their feelings can respond more empathetically to other children. Children are drawn to other children who are emotionally competent in managing their feelings and who have a positive outlook on life. In accordance with the teachings of the present invention, a process has been developed that will sequentially utilize a set of teaching aids to address the five different hierarchical building blocks defined above: (1) awareness of self and others; (2) emotional management; (3) empathy and compassion; (4) self-motivation and optimistic thinking; and (5) management of peer relationships. At times throughout the course of the following discussion, these five building blocks may be referred to as “emotional skills”.

As mentioned above, the process and methodology of the present invention are applicable to individuals of various ages and may, in fact, be useful with adults in a number of different situations (e.g., interpersonal conflict resolution, therapy sessions, team building activities, etc.). For the purposes of the current discussion, the process of the present invention will be explained in terms of an exemplary embodiment directed to young children. It is to be understood that the below examples are merely illustrative of the inventive methodology. Indeed, the principles of the present invention are equally applicable to various age levels and ranges—in some cases assessing and developing the primary emotional states (happy, sad, angry, scared, proud) and in other cases assessing and developing the second emotional states (jealous, embarrassed, worried, surprised, shy).

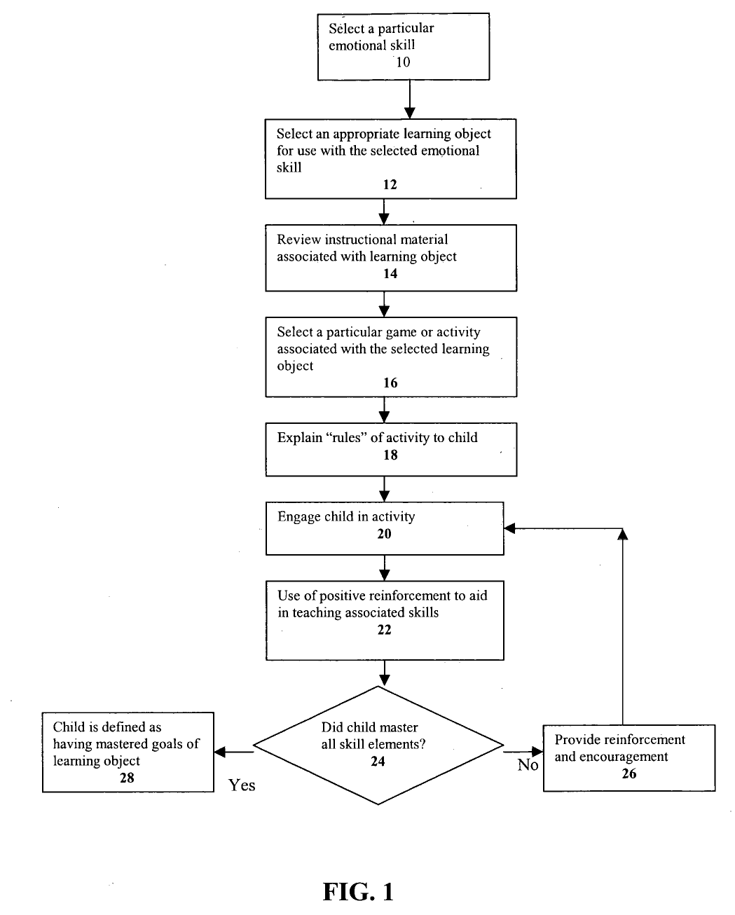

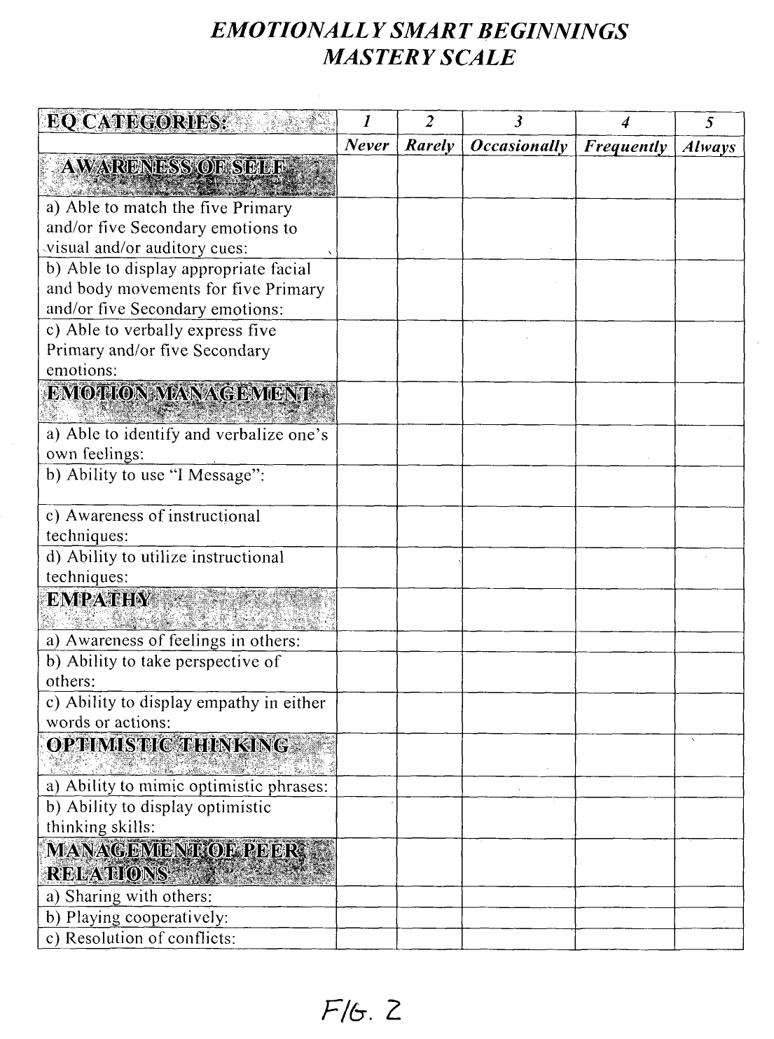

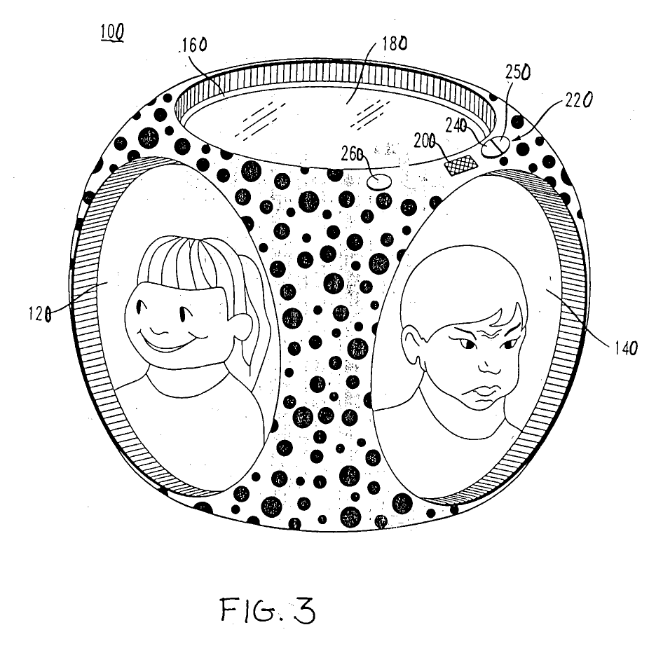

FIG. 1 outlines the overall process flow to be used in assessing and developing emotional skills in accordance with the present invention. As previously mentioned, although the process of the present invention is useful with individuals of any age, exemplary elements as shown in the chart of FIG. 1 are most suitable for use with young children. Referring to FIG. 1, the process begins with selecting a particular emotional skill that is to be assess/developed/learned (block 10). A “learning object” appropriate for the age level of the individual is then selected (block 12), where in some instances the learning object may be a certain “toy” developed for the particular purpose of learning and developing various emotional states. FIG. 3, as will be discussed below, illustrates one such learning object/toy. The parent/teacher is provided with an instructional booklet (or other media containing instructions, such as a video, audio cassette or computer software) explaining the various features of the learning object and the associated emotional learnings (block 14), perhaps using the scale as outlined in FIG. 2. A particular activity or game is then selected, based on one of the five areas of competency: (1) awareness of self and others; (2) emotional management; (3) empathy and compassion; (4) self-motivation and optimistic thinking; and (5) management of peer relationships (block 16), and the rules are explained to the child (block 18) at the level at which a child can comprehend the process. It is to be understood that these areas of competency are considered to be hierarchical, and the process of the present invention intends for an individual to master area (1) before moving on to area (2), and so on. Referring back to FIG. 1, the parent/teacher then engages the child in the activity/game (block 20), using positive reinforcement to teach the child the skills needed to achieve the chosen area of emotional competency (block 22).

At the completion of the activity/game, the parent/teacher uses the associated instructional media to determine if there are any areas where the child may need reinforcement and encouragement (decision block 24), using an “emotional intelligence” mastery scale, as defined below in association with FIG. 2. If certain areas are found in need of further mastery, the parent/teacher provides the necessary reinforcement and encouragement for the child to assist him/her in developing this new skill (block 26) and the process then returns to block 20 to repeat the game-playing activity. Returning to decision block 24, if the parent/teacher believes that reinforcement is not required, the child is defined as having mastered the goals of that particular toy/game (block 28), and the associated area of emotional competency is defined as being well-understood.

FIG. 2 contains a chart of definitions associated with an emotional intelligence mastery scale 40 which may be used in association with decision block 24 of the inventive process as outlined in FIG. 1. In particular, the mastery scale of FIG. 2 may be used, in one example, to assess a child's success in mastering the play associated with a learning object, such as a toy. It is to be understood that the specific scale of FIG. 2 is exemplary only, and various other interpretations and/or modifications can be made to this scale and still provide for an accurate assessment of a child's development. Referring to FIG. 2, the five specific building blocks of emotional intelligence, as outlined above, are shown as five separate categories on the scale, with each category including two or more specific “outcomes” to be assessed and evaluated when using the inventive process. An evaluation scale is shown as included as part of mastery scale 40, where this particular chart is broken into a five-part range for assessing an individual's performance, with the lowest end of the range (shown as “1”) defined as “never” and the highest end of the range (shown as “5”) defined as “always”, with the remaining elements within the range defined as “rarely”, “occasionally”, and “frequently”. Various other ranges and definitions may be used. Referring to FIG. 2, the first emotional intelligence building block, “awareness of self and others” has been further defined as including three different elements: a) able to match the five primary and/or five second emotions to visual and/or auditory cues; b) able to display appropriate facial and c) able to verbally express the five primary and/or five secondary emotions. Thus, when using mastery scale 40 of FIG. 2, an individual performing the assessment of a child after playing a particular emotional learning game associated with the this building block, would review these three elements and determine which category along the scale (from 1 to 5) is most applicable for that child.

The second building block, emotional management, is shown in FIG. 2 as defined by four separate elements: a) able to identify and verbalize one's own feelings; b) ability to use “I message” statements; c) awareness of the instructional techniques associated with the inventive process; and d) ability to utilize the instructional techniques of the present invention. Again, during the course of utilizing a learning object associated with “emotional management”, a teacher/parent/instructor would refer to each of these four elements and assess the individual's performance using the 1-5 scale as discussed above. In a similar manner, the building block of empathy is broken down into a set of three elements that can be evaluated along the mastery'scale: a) awareness of feelings in others; b) ability to take the perspective of others; and c) ability to display empathy in either words or actions. The optimistic thinking building block is defined as including the elements of: a) ability to mimic optimistic phrases; and b) ability to display optimistic thinking skills, as shown in FIG. 2, and the management of peer relations building block is shown in FIG. 2 as including the elements of: a) sharing with others; b) playing cooperatively; and c) resolution of conflicts.

Thus, in accordance with the present invention, the parent/teacher will refer to an instructional aid, such as the mastery scale of FIG. 2, to assist in evaluating the child's progress in developing emotional intelligence when using one of the associated toys, games or other learning objects.

FIG. 3 illustrates one exemplary learning object 100 (in this example, a toy) that may be used to address the various aspects of the first emotional building block competency area (self-awareness). The toy, as fully described in our co-pending U.S. application Ser. No. 10/417,641 filed Apr. 17, 2003, aids in learning to recognize a feeling when it occurs, then the thought that preceded the emotion. A set of holograms (or other appropriate illustrations) are presented are presented on different faces 120 and 140 on object 100 (each appropriate for the particular age level), allowing the child to identify and label various emotional states. The child may then progress to drawing each of the emotional states, mirroring the facial expression associated with each state (face 180 illustrated as having a reflective surface), and then listening to a recording associated with each state (controls 220, 240, 250, and associated speaker 200) used to provide record/playback functions) A game control button 260 may be used to activate different learning activity games included with object 100.

It is to be understood that various other learning objects, following the same or similar pattern, may then be used (in a hierarchical fashion) with each of the remaining four emotional competency areas to assist a child in developing a healthy emotional intelligence in accordance with the teachings of the present invention.

What is claimed is:

1. A process for assessing and developing an individual's emotional intelligence, based on a hierarchical series of emotional competency building blocks associated with pre-defined emotional states, the process comprising the steps of:
selecting a learning object for use in teaching a selected emotional competency building block;
determining an activity, utilizing the learning object, that teaches the selected emotional competency building block;
engaging the individual in the activity;
identifying areas in which the individual needs reinforcement and, if necessary, repeating the activity, otherwise,
defining the individual as having mastered the selected emotional competency building block.

2. The process as defined in claim 1 wherein the hierarchical series of emotional competency building blocks comprises, in sequence, (1) awareness of self and others; (2) emotional management; (3) empathy and compassion; (4) self-motivation and optimistic thinking; and (5) management of peer relationships.

3. The process as defined in claim 1 wherein the selected learning object is a toy developed to assist in teaching one or more of the selected emotional competency building blocks.

4. The process as defined in claim 1 wherein the selected learning object is a game developed to assist in teaching one or more of the selected emotional competency building blocks.

5. The process as defined in claim 1 wherein the selected learning object is a story developed to assist in teaching one or more of the selected emotional competency building blocks.

6. The process as defined in claim 1 wherein in performing the identifying step, an emotional intelligence mastery scale is utilized to determine the individual's level of performance.

7. The process as defined in claim 6 wherein each unit in the scale may comprise at least three separate levels of performance: (1) always achieves goal; (2) occasionally achieves goal; and (3) never achieves goal.

8. The process as defined in claim 1 wherein each one of the building blocks is defined for young children in the age range of 3-5.

9. The process as defined in claim 1 wherein the pre-defined set of emotional states comprises at least a primary set of emotional states including: happy, sad, angry, scared and proud.

10. The process as defined in claim 1 wherein the pre-defined set of emotional states comprises at least a secondary set of emotional states including: jealous, surprised, worried, embarrassed and shy.
